(19) United States
(12) Patent Application Publication
(10) Pub. No.: US 2011/0320261 A1
(43) Pub. Date: Dec. 29, 2011

(54) Quality Scoring System for Internet Advertising Loci

(76) Inventors: Jayant Kadambi, Mountain View, CA (US); Ayyappan Sankaran, San Jose, CA (US)

(21) Appl. No.: 13/163,691

(22) Filed: Jun. 18, 2011

Related U.S. Application Data
(60) Provisional application No. 61/356,652, filed on Jun. 20, 2010.

(51) Int. Cl. G06Q 30/00

(52) U.S. Cl. 705/14.42; 705/14.41

(57) ABSTRACT

An Internet advertising locus scoring system including a locus metrics database, a locus parameters database, a scoring engine and a system controller coupled to the locus metrics database, the locus parameters database and the scoring engine. The locus metrics database and the locus parameters database may be at least partially linked and may be at least partially distributed. In an embodiment, the scoring engine may include a weight function operating on at least some of the locus metrics.

### CROSS REFERENCE TO RELATED APPLICATIONS

This application claims the priority of U.S. Provisional Patent Application Ser. No. 61/356,652, filed Jun. 20, 2010, incorporated herein by reference.

### BACKGROUND

Electronic commerce, often known as “e-commerce”, includes the buying and selling of products or services over electronic systems such as the Internet. The amount of trade conducted electronically has grown immensely with the widespread adoption of Internet technology. One particularly explosive area of growth in e-commerce is in the field of advertising and, in particular, video advertising on the Internet.

Advertising is a common way or seller of goods and/or services to generate sales. In traditional media, such as television and print media, an advertisement may be seen by a wide demographic audience. Generally, only a small percentage of the audience will have any interest in purchasing the goods or services. Also, with traditional media, there is typically a limited supply of space for advertisements. In the art, the amount of resources (e.g., physical space, time, etc.) available for advertising is sometimes referred to as “inventory.”

The inherent nature of the Internet is that it creates ever-increasing amounts of advertising inventory. This is because web technology can generate an advertising message image (called an “impression”) each time a web page (or other, for example, html based platform) is accessed. Since multiple users can access Internet content simultaneously, and since the number of Internet users and web pages is constantly increasing, the “inventory” of advertising space on the Internet is almost limitless.

As a result of large surplus of inventory, there is competition by websites (“publishers”) for advertisers and entities that represent advertisers. That is, since many advertisers are represented by ad agencies, ad networks, and/or other entities managing the distribution of advertising (collectively “ad networks”) this competition for advertisers extends to such entities. Since most web publishers offer some form of fee splitting arrangement with ad networks, some of this competition may be reflected by the profit margins they offer to ad networks. Also, different websites cater to different demographics, have different “click-through” rates, etc., all of which can be used to attract the interest of advertisers and ad networks.

Because of competition, publishers are interested in attracting well paying advertising by optimizing website content, adjusting the presentation of advertising, attracting viewers of demographics that are desirable to advertisers, etc. Adjusting these and other aspects of their advertising locus has been a relatively inefficient hit-or-miss process of guesswork and experimentation.

Furthermore, advertisers desire to place their advertisements on high quality web pages and other advertising loci so at to obtain the best value for their advertising dollar. This, also, has been a hit-or-miss process based upon intuition and time consuming feedback.

These and other limitations of the prior art will become apparent to those of skill in the art upon a reading of the following descriptions and a study of the several figures of the drawing.

### SUMMARY

Various examples are set forth herein for the purpose of illustrating various combinations of elements and acts within the scope of the disclosures of the specification and drawings. As will be apparent to those of skill in the art, other combinations of elements and acts, and variations thereof, are also supported herein.

An Internet advertising locus scoring system, set forth by way of example and not limitation, includes: a locus metrics database; a locus parameters database; a scoring engine; and a system controller coupled to the locus metrics database, the locus parameters database and the scoring engine. In a further example, the locus metrics database and the locus parameters database are at least partially linked. In a still further example, at least one of the locus metrics database and the locus parameters database is at least partially distributed. In yet another example, the scoring engine includes a weight function operating on at least some of the locus metrics. In a still further example, the weight function is a weighted sum function. In a still further example, the weight function is a weighted average function. In a still further example, the weighted function includes weight coefficients derived from the locus parameters database. In yet another example, the weighted function is implemented by a neural network. In yet another example, a scoring database is coupled to the system controller. In a still further example, at least two of the scoring database, the locus metrics database and the locus parameters database are at least partially linked. In another example, at least one of the locus metrics database and the locus parameters database is at least partially distributed. In yet another example, a report generator coupled to the system controller. In a still further example, the report generator produces a ranked list of advertising loci. In yet another example, the ranked list is associated with a demographic profile.

A method for ranking Internet advertising loci, set forth by way of example and not limitation, includes: obtaining for a plurality of Internet advertising locus a plurality of locus metrics and a plurality of locus parameters; generating a plurality of scores associated with the plurality of Internet advertising locus; and ranking at least a subset of the plurality of Internet advertising locus based upon the plurality of scores. In a further example, generating the plurality of scores includes a weight function operating on at least some of the locus metrics. In a still further example, the weight function is at least one of a weighted sum function and a weighted average function. In another example, the weight function includes weight coefficients. In yet another example, the weighted function is implemented by a neural network.

A method for developing a quality ranking of advertising loci, set forth by way of example and not limitation, includes: developing quality scores for advertising loci; and ranking the advertising loci based upon the quality scores. The ranked advertising loci can be used by publishers to improve the quality of their advertising loci and can be used by advertisers in their selection of advertising loci.

A video advertising scoring system for websites, web pages, and/or other Internet loci, set forth by way of example and not limitation, develops one or more advertising “quality scores” which are correlated to their “advertising quality.” The websites can be “ranked” by their quality scores to provide relevant information pertaining to video advertising decisions made with respect to the websites by, for example, advertisers, ad networks and publishers.

Quality scores can be used advantageously by both advertisers and publishers. For example, advertisers can optimize their advertising budget by placing their advertisements with publishers which meet their quality criteria. Publishers, on the other hand, can use quality scores to improve their attractiveness to advertisers by, for example, changing their content and/or lowering their price.

These and other examples of combinations of elements and acts supported herein as well as advantages thereof will become apparent to those of skill in the art upon a reading of the following descriptions and a study of the several figures of the drawing.

### BRIEF DESCRIPTION OF THE DRAWINGS

Several examples will now be described with reference to the drawings, wherein like elements and/or acts are provided with like reference numerals. The examples are intended to illustrate, not limit, concepts disclosed herein. The drawings include the following figures:

FIG. 1 illustrates an example system supporting an advertising locus scoring process;

FIG. 2 is a block diagram of an example computer, computerized device, proxy and/or server which may form a part of the system of FIG. 1;

FIG. 3 is a block diagram of an example advertising locus scoring system;

FIG. 4 is a state diagram of an example advertising locus scoring process;

FIG. 5 is a flow diagram of an example scoring database update process; and

FIG. 6 is a table of example metrics data derived from a number of publishers over time along with example normalized values and Publisher Quality Scores (PQS) associated therewith.

### DETAILED DESCRIPTIONS

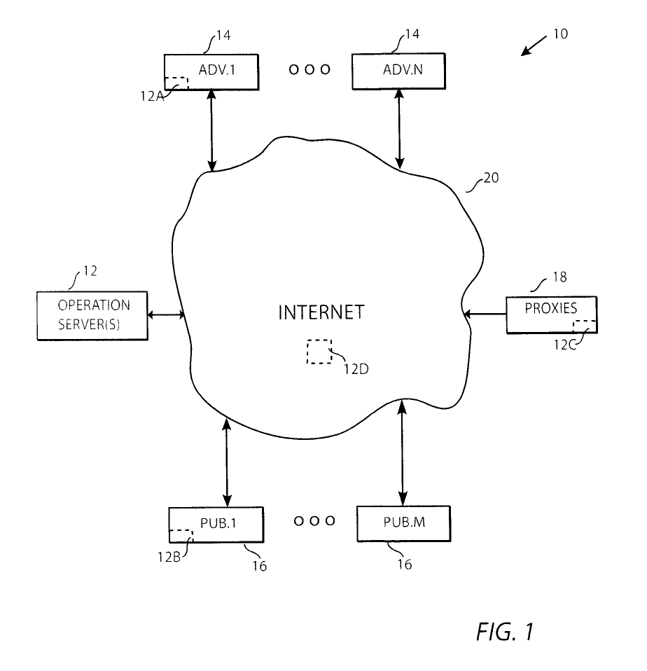

FIG. 1 illustrates a system 10 supporting an advertising locus scoring process in accordance with a non-limiting example. In this example, the system 10 includes one or more operation servers 12, one or more advertiser computers 14 and one or more publisher server systems 16. The system at 10 may further include other computers, servers or computerized systems such as proxies 18. In this example, the operation servers 12, advertiser computers 14, publisher server systems 16, and proxies 18 can communicate by a wide area network such as the Internet 20 (also known as a “global network” or a “wide area network” or “WAN” operating with TCP/IP packet protocols).

The operation servers 12 can be implemented as a single server or as a number of servers, such as a server farm and/or virtual servers, as will be appreciated by those of skill in the art. Alternatively, the functionality of the operation servers 12 may be implemented elsewhere in the system 10 such as on an advertiser computer 14, as indicated at 12A, on the publisher server system 16, as indicated at 12B, on a proxy 18 as indicated at 12C or as part as cloud computing as indicated at 12D, all being non-limiting examples. As will be appreciated by those of skill in the art, the processes of operation servers 12 may be distributed to these systems within system 10.

In an example, the operation servers provide middleman services between the advertisers and the publishers to facilitate the buying and selling of advertisements over the Internet. In other examples, the operation server(s) provide middleman and/or facilitation services for client computers and resource server systems to enhance a variety of e-commerce activities.

In the example of FIG. 1, the system 10 includes a plurality of advertiser computers 14 {ADV. 1, ADV. 2, . . . , ADV. N}. ADV. 1 can be, for example, a manufacturer of soft drinks, ADV. 2 can be a computer manufacturer and ADV. N can be, for example, an accounting firm. Alternatively, an advertiser can be an advertising agency acting as a middleman in the purchase of advertising for a client. While each of the advertising computers 14 may be implemented as a single computer, such as a personal computer or computer workstation, they can also represent other computer configurations, such as a computing cluster on a local area network (LAN).

The publisher server systems 16 can each represent one or more servers, such as a server farm. In the example of FIG. 1, the system 10 includes a plurality of publisher server systems 16 {PUB. 1, PUB. 2, . . . , PUB. M}. For example, PUB. 1 can be an Internet portal, PUB. 2 can be a search engine, and PUB. M can be a news website. As noted previously, one or more of the publisher server systems 16 can implement some or all of the functionality of operation servers 12.

Proxies 18 can be computers, servers, or clusters of servers which serve as intermediaries or proxies between the operation servers, advertising computers and/or publisher server systems 16. As noted previously, some or all of the functionality of operation servers 12 may be implemented on proxies 18.

It will again be noted that the system 10 as illustrated in FIG. 1 is but one example of such a system. By way of non-limiting example, the advertiser computers 14 can be generalized to be virtually any form of client computer. By way of further non-limiting example, the publisher server systems 16 can be generalized to be virtually any form of resource server systems. It will therefore be appreciated that while certain example as described herein are directed to an e-commerce advertising sale and purchasing that there are other many other examples which can be implemented by the system 10 as described herein.

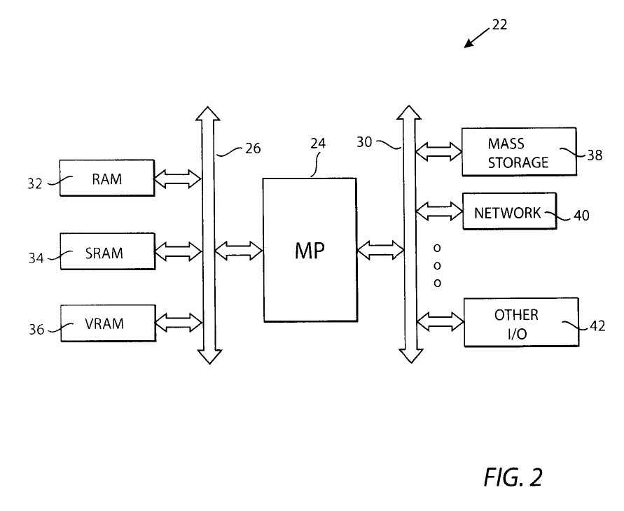

FIG. 2 is a simplified block diagram of a computer and/or server 22 suitable for use in system 10. By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

It should be noted that other computerized devices may be within the scope of the system of FIG. 1. For example, many devices, such as cellular telephones, personal digital assistants (PDAs), network appliances, tablet computers and other portable and non-portable devices can derive information, provide information, or otherwise interact with system 10. In many cases, these devices support electronic advertising.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment.

It should further be noted that, in some instances, an ad network is, essentially, transparent to advertisers, publishers or both. That is, an ad network may be considered to be a publisher or collection of publishers to an advertiser and/or an ad network may be considered to be an advertiser or collection of advertisers to a publisher. See, for example, U.S. patent application Ser. No. 12/817,095, filed Jun. 16, 2010, entitled “System, Method and Apparatus for Automated Resource Allocation among Multiple Resource Server Systems,” incorporated herein by reference.

As used herein, an “Internet advertising locus” refers to a location or instance of an advertisement viewed after being delivered to a computer, computerized device or other “end point”, either directly or indirectly, over the Internet. In general, a number of Internet advertising locus will be referred to as “Internet advertising loci.” However, in some instances an “Internet advertising locus” may be a set of “Internet advertising loci.” For example, a website, comprising a number of web pages, may be considered to be an Internet advertising locus even though each web page itself could also be considered to be an Internet advertising locus. Alternatively, “Internet advertising loci” could be considered to be an “Internet advertising locus” filtered by, for example, one or more demographics. For example, an advertisement on a web page may be considered to be a different locus when filtered for “male” and “female” viewers.

A very common Internet advertising locus is a web page. In such an example, the advertising locus may, for example, not only be associated with the URL of the web page, but also its relative position on the web page and proximity to other elements of the web page.

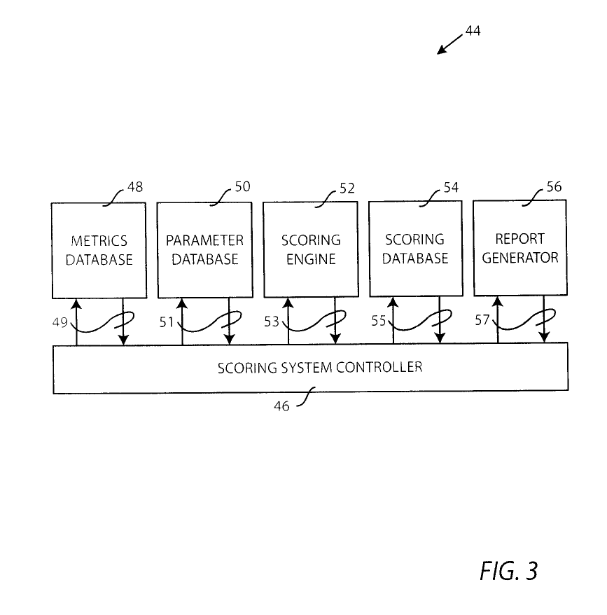

In FIG. 3, a block diagram of an example advertising locus scoring system 44 includes a scoring system controller 46, a metrics database 48, a parameter database 50, a scoring engine 52, a scoring database 54 and a report generator 56. It should be noted that the various elements of scoring system 44 may be real and/or virtual and some or all of the elements may comprise computer implements processes.

For the purpose of illustrative examples, the advertising locus scoring system will be described with respect to video advertisements viewable via over the Internet, it being understood that other forms of communication media, whether or not for the purpose of advertising (such as non-commercial communications) are alternate examples of “advertisements” and “advertising” as used herein.

Therefore, in this example, the video advertisement may be associated with a website, or web page, or particular location on a web page. Typically, the video advertisement includes a “play” button which, when activated by the click of a mouse, will start to play the video advertisement (this is referred to herein as a “click-through”). Also typically, the video advertisement can be played to completion or stopped before completion. The amount of the video advertisement which is played is referred to herein as “play-through”, and may be measured in, for example, as percentages (e.g. Video Completion Rate or “VCR”) or in seconds. In some cases, the video advertisement can include links to other resources to provide additional information, content, the ability to order a product, or feeds which can enhance the video advertisement experience, by way of non-limiting examples.

Websites, objects embedded therein, web servers and other Internet resources often have the ability to monitor website activity, including the display of, and/or interaction with, advertisements. The data derived from such monitoring functions can provide metrics which can be used to analyze the performance of the advertising. For example, one common metric is “impressions”, which is the number of times that a web page including a particular advertisement has been presented on a web page, in this example, over a period of time. Another common metric is “click-through rate” which is the percentage click-throughs to impressions in a period of time. Yet another common metric is “view through rate” or Video Completion Rate (VCR), which is the average rate of view-through (often expressed as a percentage) in a period of time. These and other metrics well known to those of skill in the art can be derived from advertising loci and accumulated for archival purposes and analysis.

As noted above, “advertising loci” may have other uses other than advertising, such a communication, training or entertainment. Metrics associated with the advertising loci are nonetheless also useful for archival purposes and analysis. Furthermore, “advertising loci” can appear in other places than web pages. By way of non-limiting example, an advertising locus can be displayed on a screen of a cell phone or on the screen of a tablet computer. The “end point”, e.g. the computerized apparatus upon which the advertisement is displayed to a user is also a useful metric for the purpose of analysis.

In the example of FIG. 3, metrics derived from various advertising loci can be stored in metrics database 48 for concurrent and/or subsequent analysis. The metrics database 48 may be localized and/or distributed and may be found, in part or in whole, in various locations in the example system of FIG. 1, by way of non-limiting examples. Scoring system controller 46 can engage in bidirectional communication with the metrics database 48 as indicated at 49.

A parameter database 50 can also be seen in the example of FIG. 3. Parameter database 50 can include additional information concerning Internet advertising loci. For example, database 50 can include demographic information, such as the age range or sex of viewers, the end points, etc., which may be derived from the advertising loci or elsewhere, either concurrently or over time. As another example, the parameter database may include weighting factors for metrics of the metric database 48. The parameter database 50 may be localized and/or distributed and may be found, in part or in whole, in various locations in the example system of FIG. 1, by way of non-limiting examples. Scoring system controller 46 can engage in bidirectional communication with the parameter database 50 as indicated at 51. Furthermore, the metrics database 48 and parameter database 50 may be integrated as a unified real and/or virtual database or may be linked as real and/or virtual databases.

Scoring system 44, in this example, further includes a scoring engine 52 which can be used to generate a score associate with an Internet advertising locus. In the present example, scoring engine 52 operates on one or more metrics derived from metrics database 48 to develop a score which can characterize the advertising locus. If the scores thus derived are directly related to the desirability of advertising at that locus, the score can be considered to be a “quality score” for that advertising locus. By providing standardized quality scores for advertising loci comparisons can be made for the purpose of making advertising decisions and/or making improvements to the “quality” of the advertising locus. Scoring engine 52 is, in this example, in bidirectional communication with scoring system controller 46 as indicated at 53.

Scores developed by scoring engine 52 may be stored in a scoring database 54 which, in this example, is in bidirectional communication with scoring system controller 46 as indicated at 55. The scoring database 54 may be localized and/or distributed and may be found, in part or in whole, in various locations in the example system of FIG. 1. Furthermore, the scoring database 54, metrics database 48 and parameter database 50 may be integrated as a unified real and/or virtual database or may be linked as real and/or virtual databases. By “database” it is meant herein any ordered storage of data allowing for its systematic retrieval. For example, a database may be a flat database, a table, a relational database, etc.

Report generator 56 is, in this example, coupled to scoring system controller 46 for bidirectional communication as indicated at 57. Report generator 56 may be used, for example, to create reports derived from data in the scoring database 54 or elsewhere. For example, report generator 56 can generate an ordered quality list or “quality ranking” of advertising loci. The score associated with a particular advertising locus can provide an indication of the desirability or “quality” of that advertising locus.

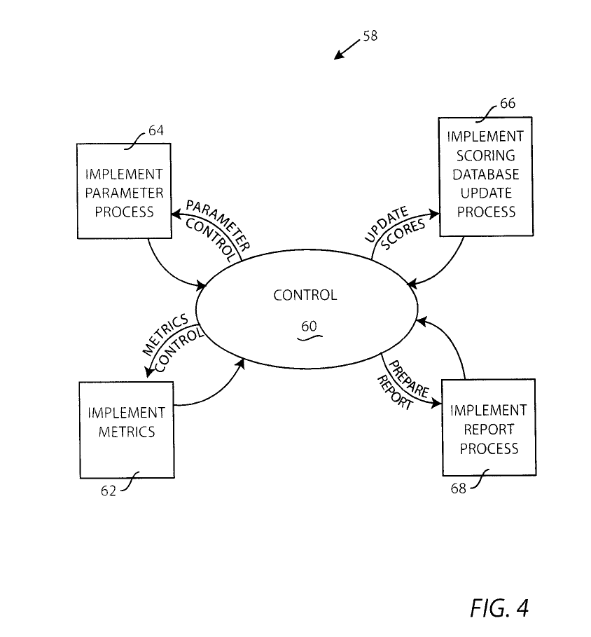

In FIG. 4, a state diagram of an example advertising locus scoring process 58 includes a central control process 60, a metrics process 62, a parameter process 64, a scoring database update process 66 and a report process 68. Central control 60, in this example, can implement a metrics process 62, such as retrieving stored metrics from the metrics database 48 (see FIG. 3). Likewise, central control 60, by way of example, can implement parameter process 64, such as storing weights and/or demographic parameters in, for example, parameter database 50. Central control 60 can also implement a scoring database update process 66 and/or an implement report process 68 on, for example, scoring engine 52 and/or report generator 56, respectively, of FIG. 3.

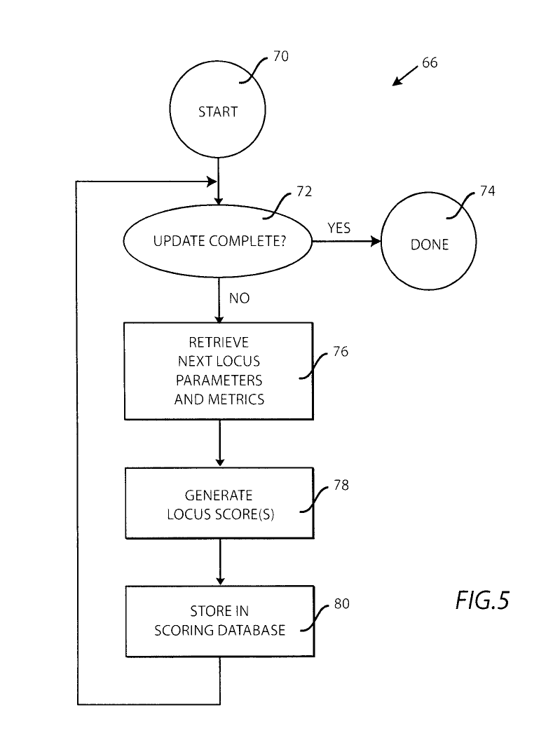

In FIG. 5, an example scoring update process 66 of FIG. 4 is illustrated in greater detail. Process 66 begins at 70 and, in a computer implemented act or “operation” 72, it is determined if the update process is complete. If it is, process 66 is done as indicated at 74 and process control returns to central control 60 (see FIG. 4). If not, the next locus parameters and metrics are retrieved in an operation 74. An operation 78 then generates one or more locus scores, which are stored in, for example, the scoring database (see FIG. 3).

Generating Quality Scores

Quality scores may be generated, by way of non-limiting example, using a weight function. A weight function is a mathematical technique used when performing, for example, a sum, integral or average in order to give some elements more “weight” or influence on the result than the other elements in the same set. In this example, the elements of a set are selected from metrics associated with an advertising locus and the weights are either constants or functions associated with the advertising locus and, in certain examples, associated demographics. As used herein, a “quality score” may be referred to as a Publisher Quality Score or “PQS.”

One type of weight function is the weighed sum, as given by Equation 1, below:

Σᵢ₌₁ⁿf(i)m(i) Equation 1

Where m(i) is the metric of i^{th} selected metrics associated with a locus and f(i) is a weighting function associated with the metric m(i). The weighting function can be, as noted above, a constant stored in, for example, an array, table or other data structure in the parameter database 50. Alternatively, f(i) can be a function of a number of constants and/or variables, including demographic variables, which also can also be, for example, stored in parameter database 50.

Another form of weight function is the weighted average. Weighted averages or “weighted means” are commonly used in statistics to compensate for the presence of bias. The weighted mean is similar to the arithmetic mean (the most common type of “average”) except instead of the metrics contributing equally to the final average, some metrics contribute more than other. The notion of weighted mean plays a role in descriptive statistics and also occurs in a more general form in several other areas of mathematics. As is well known to those skilled in the art, there are other forms of weighted means, including weighted geometric means and weighted harmonic means.

Once a raw quality score is obtained, it may be normalized to be more easily compared by human analysts. For example, if the raw quality scores are in the range of 0 to 1, they may be normalized to range from 0 to 100 by multiplying by 100. Normalized scores tend to be easier for the human brain to retain and compare.

Given a sufficiently large scoring database 66, an artificial neural network can also be trained to provide quality scores. An artificial neural network (ANN), often referred simply to a “neural network”, is a computational model which simulates the structural and/or functional aspects of biological neural networks. Neural networks include an interconnected group of artificial neurons and process information using a connectionist approach to computation. In most cases, neural networks are adaptive systems that change their structures based upon external or internal information that flows through the network during the learning phase. Most neural networks are non-linear statistical data modeling tools which can be used to model complex relationships between inputs and outputs or to find patterns in data.

In order to be properly “trained”, many examples should be applied to the neural net during the training phase. For a particular advertising locus, the locus metrics and locus parameters are applied to inputs of the neural net, and the quality score, as stored in the scoring database 54, is applied to the output. The neural network then internally adjusts the “weights” of its neurons such that the output is a weighted function of the inputs. After many examples the neural net “learns” how to generate the proper quality score based upon any arbitrary set of inputs.

An advantage of a trained neural network is that it is not necessary to know how the correct answer is derived. In fact, many more metrics can be input into a neural network than could be conveniently handled by human-assisted calculations. This has the advantage of increased robustness and the possibility of the neural network “discovering” transfer function relationships not considered by human designers. Once properly trained, a neural network can operate without any human interaction with respect to the selection of weights for a weight function.

For a new system, e.g. a system where the scoring database has not yet been started, it is preferable to start with a simple weight function scoring engine where a human operator chooses a few metrics to follow and assigns weight constants to those metrics based upon expert knowledge and, to a degree, human intuition. The weights are all fractions, and the sum of the weights is “1.” As the scoring database is populated and additional experience is accumulated, the weight constants can be adjusted by changing the weights and/or additional metrics can be added. In addition, weight functions can be selectively assigned and different sets of weights can be associated with different demographics or “demos.” For example, one set of weights can be associated for an advertising locus for male viewers and another set of weights can be associated with the same advertising locus for female viewers.

The scoring engine 52 can therefore become increasingly sophisticated and accurate through incremental human intervention. However, at some point the interrelationships between a many potential metric and parameters may limit the sophistication of the scoring engine 52. At that point, if a sufficiently large scoring database 54 has been developed, the scoring engine 54 may be supplemented by, or replaced with, a neural network.

It should be noted that the examples set forth above for scoring engine 52 are not exhaustive of potential technologies. For example, the scoring engine can also be implemented using expert system technologies. Furthermore, scoring engine performance may be an interactive process with other inputs, processes and systems.

### Example 1

### Homogeneous Metrics

The following example illustrates a generation of PQS by, for example, scoring engine 52 implementing a weight function. Suppose that, for a particular advertising locus, such as on a web page, two metrics are tracked: 1) a click-through rate of 5%; and 2) a view-through rate of 75%. Also, further assume that the weight of the click-through rate (CTR) is 0.6 and the weight of the view-through rate (VCR) is 0.4, i.e. click-through is weighted more heavily in this example than view-through rate. Using Equation 1, the PQS for the advertising locus as a weighted sum is:

Q=0.6(5)+0.4(75)=3+30=33

Since the units of the metrics, in this example, are percentages (i.e. the metrics are homogeneous), no normalization is need.

Continuing with the same example, assume that the weights given above were for the demographic “female” and that the weights for the demographic “male” are 0.4 for click-through rate and 0.6 for view-through rate. Then, applying Equation 1 for the advertising locus as a weighted sum for the demographic “male” we obtain:

Q′=0.4(5)+0.6(75)=2+45=47

It can therefore be seen that the PQS for the given advertising locus is 33 for females but 47 for males. As a result, advertisements targeting males will be more effective at this advertising locus than advertisements for females.

### Example 2

### Heterogeneous Metrics

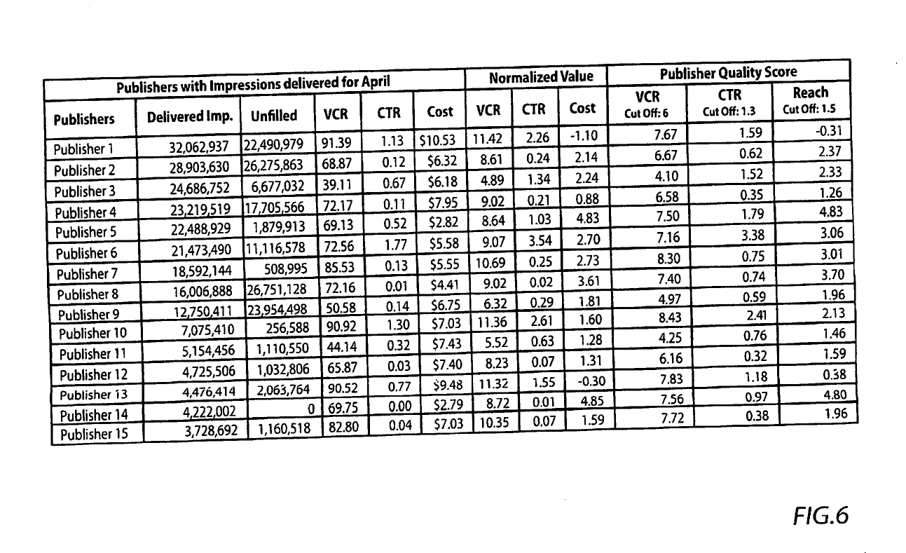

Another example of the development of Publisher Quality Scores will be with reference to the table of FIG. 6. In this non-limiting example, three metrics are used: Video Completion Rate (“VCR”), Click Through Rate (“CTR”) and Cost of Inventory (“Cost”).

As mention above, VCR corresponds to the average percentage of that a video is played. For example if, on the average, 27 seconds of a 30 second video is played, its VCR is 90%. A high VCR can be considered by advertisers to be desirable as it implies that their message or branding is being effectively communicated to consumers.

CTR is the percentage of time that a video is “selected” while it is being played. For example, if the video is being played on a web page, it can be selected by “clicking” on the video by activating a pointing device such as a mouse. Typically, clicking on a playing video advertisement being displayed on a web page will open the advertiser's web page.

Cost is the cost of inventory and is often measured in cost per thousand (“CPM”). Cost is related to “Reach”, e.g. the number of impressions made by the advertiser.

It should be noted that the ranges and/or units of measure for the three example metrics of VCR, CTR and Cost are heterogeneous. For example, VCR can range between 0-100%, CTR can range from 0-5% and Cost can range from $0-$30. Since it is preferable for a PQS to reflect a composite of metrics, some form of normalization of the metrics data may be desirable. It will be appreciated by those of skill in the art that there are many normalization techniques that may be used. For example, a linear scaling transform can be used to normalize heterogeneous metrics data.

By way of non-limiting example, suppose that a metric's data has a range or scale from A to B and that this is to be converted or “normalized” to a scale of 1 to 10, where A maps to 1 and B maps to 10. Since, in this example, a linear mapping algorithm is being used, the point midway between A and B maps to halfway between 1 and 10, or 5.5. In accordance with the foregoing criteria, the following (linear) equation can be applied to any number x on the A-B scale:

y=1+(x−A)*(10−1)/(B−A) (Equation 1)

It should be noted that if x=A, this gives y=1+0=1 as desired, and if x=B, y=1+(B−A)*(10−1)/(B−A)=1+10−1=10, as desired. This equation works even if A>B.

It should be further noted that Equation 1, above, can be generalized to situations where the final scale is between any two numbers, not necessarily 1 and 10, but replacing them by C and D respectively in the equation. The situation x=A will get mapped to y=C and x=B will get mapped to y=C+(D−C)=D.

In the example table of FIG. 6 metrics measured for forty hypothetical customers during the month of April are displayed. The first column of the table indicates the publisher, the second column is the number of delivered impressions, the third column is the “unfilled inventory”, and the fourth, fifth and sixth columns are the VCR, CTR and Cost for the publishers as measured during the month of April.

The seventh, eighth and ninth columns of FIG. 6 include normalized values for the metrics VCR, CTR and CTR. By normalizing the metrics, a number of different Publisher Quality Scores (PQS) can be derived, as illustrated in columns 10, 11 and 12 of the table. These different PQS scores can be weighted, for example, to reflect the preferences of advertisers.

For example, if an advertiser is interested in “brand lift”, e.g. better brand awareness, VCR might be weighted more heavily than CTR. Alternatively, if interaction or Reach is more important to an advertiser, CTR or Cost would become more heavily weighted.

The various Publisher Quality Scores can also be provided with a “cutoff” value. For example, the VCR PQS might have a cutoff value of 6, the CTR PQS might have a cutoff value of 1.3 and the Reach might have a cutoff value of 1.5. That is, any publisher not meeting the cutoff values for the desired PQS might not, in this example, be given any advertisements to run.

It will be appreciated that the PQS values are useful tools in deciding with which publishers advertisements should be placed. Since the PQS values can be generated on a real-time basis, the decision as to where advertisements should be placed can change dynamically. However, in many instances it has been found that the PQS values (or at least the use of new PQS values) should be updated at intervals of time which allow short-term anomalies to average out. For example, PQS numbers may be updated every 1, 5, 15, 30, 60 or 120 minutes. The PQS numbers could also be updated daily, weekly, month or at longer intervals, or in seconds or fractions of a second.

Iterative Updates to Scoring Database

In an example embodiment, the scoring database may be updated on a periodic basis, e.g. every 15 minutes. In this example, central control 60 activates the process 66 to implement the scoring database update process every 15 minutes, drawing from the then-current metrics from metrics database 48 and parameter database 50.

To prevent the quality scores varying widely with each update, the most recent metrics and/or parameters can be averaged with historical metrics and/or parameters. For example, the metrics applied to the scoring database update process can be the average of metrics and parameters during a “window” of time moving forward in 15 minute steps. The window can be chosen to be of sufficient time-length to smooth out any short-term spikes or dips in quality scores but not so long as to understate or overstate the current quality level. For example, the window can be 1-5 days in length.

It should also be noted that second, third, etc. order information can be derived from the iterative collection of metric data. For example, velocity (e.g. speed of change of a metric) and acceleration (e.g. acceleration of change of a metric) can be calculated and input into the scoring database update process.

Although various examples have been described using specific terms and devices, such description is for illustrative purposes only. The words used are words of description rather than of limitation. It is to be understood that changes and variations may be made by those of ordinary skill in the art without departing from the spirit or the scope of any examples described herein. In addition, it should be understood that aspects of various other examples may be interchanged either in whole or in part. It is therefore intended that the claims herein and hereafter presented be interpreted in accordance with their true spirit and scope and without limitation or estoppel.

What is claimed is:

1. An internet advertising locus scoring system comprising:
a locus metrics database;
a locus parameters database;
a scoring engine; and
a system controller coupled to said locus metrics database, said locus parameters database and said scoring engine.

2. An internet advertising locus scoring system as recited in claim 1 wherein said locus metrics database and said locus parameters database are at least partially linked.

3. An internet advertising locus scoring system as recited in claim 1 wherein at least one of said locus metrics database and said locus parameters database is at least partially distributed.

4. An internet advertising locus scoring system as recited in claim 1 wherein said scoring engine includes a weight function operating on at least some of said locus metrics.

5. An internet advertising locus scoring system as recited in claim 4 wherein said weight function is a weighted sum function.

6. An internet advertising locus scoring system as recited in claim 4 wherein said weight function is a weighted average function.

7. An internet advertising locus scoring system as recited in claim 4 wherein said weighted function includes weight coefficients derived from said locus parameters database.

8. An internet advertising locus scoring system as recited in claim 4 wherein said weighted function is implemented by a neural network.

9. An internet advertising locus scoring system as recited in claim 4 further comprising a scoring database coupled to said system controller.

10. An internet advertising locus scoring system as recited in claim 9 wherein at least two of said scoring database, said locus metrics database and said locus parameters database are at least partially linked.

11. An internet advertising locus scoring system as recited in claim 9 wherein at least one of said scoring database, said locus metrics database and said locus parameters database is at least partially distributed.

12. An internet advertising locus scoring system as recited in claim 9 further comprising a report generator coupled to said system controller.

13. An internet advertising locus scoring system as recited in claim 12 wherein said report generator produces a ranked list of advertising loci.

14. An internet advertising locus scoring system as recited in claim 13 wherein said ranked list is associated with a demographic profile.

15. A method for ranking internet advertising loci comprising:
obtaining for a plurality of internet advertising locus a plurality of locus metrics and a plurality of locus parameters;
generating a plurality of scores associated with said plurality of internet advertising locus; and
ranking at least a subset of said plurality of internet advertising locus based upon said plurality of scores.

16. A method for ranking internet advertising loci as recited in claim 15 wherein generating said plurality of scores includes a weight function operating on at least some of said locus metrics.

17. A method for ranking internet advertising loci as recited in claim 16 wherein said weight function is at least one of a weighted sum function and a weighted average function.
